(19) United States
(12) Patent Application Publication
(10) Pub. No.: US 2007/0112967 A1
(43) Pub. Date: May 17, 2007

(54) Re-authentication system and method in communication system

(75) Inventors: Ji-Cheol Lee, Yongin-si (KR); Emin Yegin Alper, Istanbul (TR); Jun-Hyuk Song, Anyang-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/503,011

(22) Filed: Aug. 11, 2006

(30) Foreign Application Priority Data
Nov. 14, 2005 (KR) 108811/2005

(51) Int. Cl. G06F 15/16

(52) U.S. Cl. 709/229

(57) ABSTRACT

Disclosed are a system and a method for performing re-authentication in a communication system. A user Authorization, Authentication and Accounting server transmits a user Master Session Key (MSK_U), which is generated by performing user re-authentication for a mobile station (MS) according to a twice Extensible Authentication Protocol scheme, to a device Authorization, Authentication and Accounting server that generates a new user Master Session Key (MSK_U1) by using the MSK_U and a device Master Session Key generated at initial device authentication for the MS. A base station (BS) generates a Pairwise Master Key (PMK) by using the MSK_U1, and the MS and BS generate an authorization key by using the PMK.

### PRIORITY

This application claims priority to an application entitled “Re-Authentication System and Method in Communication System” filed in the Korean Industrial Property Office on Nov. 14, 2005, and assigned Serial No. 2005-108811, the contents of which are incorporated herein by reference.

### BACKGROUND OF THE INVENTION

1. Field of the Invention

The present invention relates generally to a re-authentication system and a re-authentication method in a communication system, and more particularly to a system and a method for performing re-authentication in a communication system by using a twice Extensible Authentication Protocol (EAP) (hereinafter twice EAP) scheme.

2. Description of the Related Art

It is well-known in the art that next-generation communication systems are evolving into communication systems for providing mobile stations with services enabling high-capacity data to be transmitted/received at high speed. A typical example of the next-generation communication system is an IEEE (Institute of Electrical and Electronics Engineer) 802.16e communication system.

FIG. 1 illustrates the internal structure of an IEEE 802.16e communication system employing a conventional twice EAP scheme. Hereinafter, for the convenience of explanation, the twice EAP scheme will be referred to as an “EAP-in-EAP” scheme, and an operation mode using the EAP-in-EAP scheme will be referred to as an “EAP-in-EAP” mode.

Referring to FIG. 1, the IEEE 802.16e communication system includes a Mobile Station (hereinafter MS) 100, a Base Station (hereinafter BS) 110, a device Authorization, Authentication and Accounting (AAA) (hereinafter AAA-D) server 120 and a user AAA (hereinafter AAA-U) server 130. The MS 100 performs device authentication with the AAA-D server 120 through the BS 110, and performs user authentication with the AAA-U server 130 through the BS 110. Since the IEEE 802.16e communication system uses an EAP-in-EAP scheme, authentication according to an EAP scheme is performed twice. Hereinafter, for the convenience of explanation, authentication performed using the EAP scheme will be referred to as “EAP authentication”. Of the two EAP authentications performed, the first EAP authentication is intended to authenticate a user, and the second authentication is intended to authenticate a device after the first authentication is successful.

FIG. 2 is a signal flowchart illustrating a procedure of performing re-authentication in the IEEE 802.16e communication system employing a conventional EAP-in-EAP scheme.

Similar to the authentication initially performed, re-authentication in the IEEE 802.16e communication system employing an EAP-in-EAP scheme also requires two EAP authentications, those being user re-authentication and device re-authentication. Hereinafter, for the convenience of explanation, the EAP authentication for re-authentication will be referred to as “EAP re-authentication”.

Referring to FIG. 2, when user re-authentication is needed, a BS 220 transmits an EAP-REQUEST/IDENTITY message, which requests EAP re-authentication, to an MS 200. Since messages according to an EAP scheme are transmitted/received between the MS 200 and the BS 220 by using a Privacy Key Management (PKM) version 2 (hereinafter”PKMv2)_EAP_TRANSFER (PKMv2_EAP_TRANSFER) message, the BS 220 transmits a PKMv2_EAP_TRANSFER/EAP-REQUEST/IDENTITY message to the MS 200 (step 211).

If the PKMv2_EAP_TRANSFER/EAP-REQUEST/IDENTITY message is received from the BS 220 to the MS 200, the MS 200 transmits a PKMv2_EAP_TRANSFER/EAP-RESPONSE/IDENTITY message to the BS 220 in response to the PKMv2_EAP_TRANSFER/EAP-REQUEST/IDENTITY message (step 213).

If the PKMv2_EAP_TRANSFER/EAP-RESPONSE/IDENTITY message is transmitted from the MS 200 to the BS 220, the BS 220 forwards intact the received PKMv2_EAP_TRANSFER/EAP-RESPONSE/IDENTITY message to the AAA-U server 260. In the IEEE 802.16e communication system, messages according to the EAP scheme are transmitted/received between the BS 220 and the AAA-U server 260 by using a Remote Authentication Dial-In User Service (RADIUS) protocol message, a DIAMETER protocol message or the like. Particularly, it is assumed in FIG. 2 that messages according to the EAP scheme are transmitted/received between the BS 220 and the AAA-U server 260 by using the RADIUS protocol message. Thus, the BS 220 transmits a RADIUS/ACCESS REQUEST/IDENTITY message to the AAA-U server 260 (step 215).

If the RADIUS/ACCESS REQUEST/IDENTITY message is received from the BS 220 to the AAA-U server 260, the AAA-U server 260 performs user re-authentication for the MS 200 in such a manner that it re-authenticates the PKMv2_EAP_TRANSFER messages by using a scheme such as an EAP-Message-Digest5 (EAP-MD5) or an EAP-Microsoft Challenge Authentication Protocol version 2 (EAP-MSCHAPv2) scheme (step 217). If re-authentication for the MS 200 is completed in this manner, the AAA-U server 260 and the MS 200 share a user Master Session Key (hereinafter MSK_U) (steps 219 and 221).

Subsequently, the AAA-U server 260 transmits a RADIUS/EAP-SUCCESS message containing the MSK_U and indicating that the EAP re-authentication was successful to the AAA-D server 240 (step 223). The AAA-D server 240 recognizes success in user re-authentication for the MS 200 by receiving the RADIUS/EAP-SUCCESS message from the AAA-U server 260, and determines whether the second EAP re-authentication is needed (step 225). Since both EAP re-authentication for a user and EAP re-authentication for a device must be performed in the IEEE 802.16e communication system employing the EAP-in-EAP scheme, the AAA-D server determines that the second EAP-re-authentication is necessary.

The AAA-D server 240, which has determined that the second EAP re-authentication needs to be performed, transmits a RADIUS/EAP-SUCCESS message, which indicates success in user re-authentication for the MS 200, to the BS 220 (step 227). Here, the RADIUS/EAP-SUCCESS message contains the MSK_U. The BS 220 generates the first Pairwise Master Key (PMK) (hereinafter PMK__1) by using the MSK_U contained in the RADIUS/EAP-SUCCESS message received from the AAA-D server 240 (step 229). The BS 220 also transmits a PKMv2_EAP_TRANSFER/EAP-SUCCESS message indicating success in user re-authentication to the MS 200 (step 231). Through steps 211 to 231, user/first EAP re-authentication for the MS 200 is completed. In addition, when device re-authentication is needed, the BS 220 transmits a PKMv2_EAP_TRANSFER/EAP-REQUEST/IDENTITY message to the MS 200 (step 233). If the PKMv2_EAP_TRANSFER/EAP-REQUEST/IDENTITY message is received from the BS 220 to the MS 200, the MS 200 transmits a PKMv2_EAP_TRANSFER/EAP-RESPONSE/IDENTITY message to the BS 220 in response to the PKMv2_EAP_TRANSFER/EAP-REQUEST/IDENTITY message (step 235).

If the PKMv2_EAP_TRANSFER/EAP-RESPONSE/IDENTITY message is received from the MS 200 to the BS 220, the BS 220 forwards intact the PKMv2_EAP_TRANSFER/EAP-RSPONSE/IDENTITY message in the form of a RADIUS/ACCESS REQUEST/IDENTITY message to the AAA-D server 240 (step 237).

If the RADIUS/ACCESS REQUEST/IDENTITY message is received from the BS 220 to the AAA-D server 240, the AAA-D server 240 performs device re-authentication for the MS 200 in such a manner that it re-authenticates the PKMv2_EAP_TRANSFER messages by using a scheme such as an EAP-Transport Level Security (EAP-TLS) scheme, an EAP-Transport Level Security Pre-Shared KEY (EAP-TLSPSK) scheme or an EAP-Authentication and Key Agreement (EAP-AKA) scheme (step 239). If device re-authentication for the MS 200 is completed in this manner, the AAA-D server 240 and the MS 200 share a device Master Session Key (hereinafter MSK_D) (steps 241 and 243).

Subsequently, the AAA-D server 240 transmits a RADIUS/EAP-SUCCESS message, which indicates success in the EAP re-authentication, to the BS 220 (step 245). Here, the RADIUS/EAP-SUCCESS message contains the MSK_D. The BS 220 generates the second PMK (hereinafter PMK__2) by using the MSK_D contained in the RADIUS/EAP-SUCCESS message received from the AAA-D server 240 (step 247). The BS 220 also transmits a PKMv2_EAP_TRANSFER/EAP-SUCCESS message indicating success in device re-authentication to the MS 200 (step 249). Through steps 233 to 249, device/second EAP re-authentication for the MS 200 is completed. If re-authentication up to device re-authentication is completed in this manner, the MS 200 and the BS 220 perform a Security Association & Traffic Encryption Key 3way handshake (hereinafter SA-TEK 3way handshake) operation (step 251). If the SA-TEK 3way handshake operation is completed, the MS 200 and the BS 220 generate an Authorization Key (AK) from PMK_1 and PMK_2 (steps 253 and 255).

Reference will now be made in detail to a procedure of generating the AK by using PMK_1 and PMK_2.

First, the MS 200 and the BS 220 applies PMK_1 and PMK_2 to an AK generation function such as the Dot16KDF function, thereby generating the AK. Here, the Dot16KDF function can be expressed by the following Equation (1):
AK=Dot16KDF(PMK_{—}1 ⊕ PMK_{—}2,MSID|BSID|‘AK’,160) (1)

In Equation (1), MSID denotes the identifier of an MS 200 for which EAP authentication is presently performed, BSID denotes the identifier of a BS 220, ‘AK’ represents that a key generated by the Dot16KDF function is an AK, and numeral 160 represents that the length of an AK generated by the Dot16KDF function is 160 bits. That is, the Dot16KDF function generates an AK having a length of 160 bits by using a parameter for an exclusive logical sum (XOR) operation of PMK_1 and PMK_2 and a parameter for the concatenation of MSID and BSID.

As stated in connection with FIG. 2, in the IEEE 802.16e communication system employing the EAP-in-EAP scheme, EAP re-authentication is performed twice for user authentication and device authentication even when performing re-authentication. Consequently, because of the two EAP re-authentications, the quantity of radio resources consumed increases and re-authentication time lengthens, which results in performance deterioration of the overall system.

### SUMMARY OF THE INVENTION

Accordingly, the present invention has been made to solve at least the above-mentioned problem occurring in the prior art, and an object of the present invention is to provide a system and a method for performing re-authentication in a communication system.

A further object of the present invention is to provide a system and a method for re-authenticating a user and a device together through only one EAP re-authentication in a communication system.

To accomplish these objects, in accordance with the present invention, there is provided a system for performing re-authentication in a communication system, which system includes an AAA-U server for transmitting an MSK_U, which is generated by performing user re-authentication for a MS according to an EAP-in-EAP scheme, to an AAA-D servern the AAA-D server for generating a new MSK_U termed MSK_U1, by using the MSK_U and a MSK_D having been generated at initial device authentication for the MS, and then transmitting the MSK_U1 to a BS that generates a PMK by using the MSK_U1, and generating an AK by using the PMK, and the MS for generating the AK by using the PMK.

In accordance with the present invention, there is provided a first embodiment of a method for performing re-authentication in a communication system, which method includes transmitting, from an AAA-U server to an AAA-D server, an MSK_U, which is generated by performing user re-authentication for an MS according to an EAP-in-EAP scheme, generating a new MSK__U termed an MSK_U1, in the AAA-D server by using the MSK_U and a MSK_D having been generated at initial device authentication for the MS, and then transmitting the MSK_U1 from the AAA-D server to a BS, generating a PMK in the BS by using the MSK_U1, and generating an AK in the MS and the BS by using the PMK.

In accordance with the present invention, there is provided a second embodiment of a method for performing re-authentication in a communication system, which method includes receiving, from an AAA-U server; an MSK_U, which is generated by performing user re-authentication for an MS according to an EAP-in-EAP scheme, and generating a new MSK_U termed an MSK_U2, by using the MSK_U and a MSK_D having been generated at initial device authentication for the MS, transmitting the MSK_U2 to a BS, and controlling the BS to generate a PMK by using the MSK_U2.

In accordance with the present invention, there is provided a third embodiment of a method for performing re-authentication in a communication system, which method includes receiving an MSK_U and a new MSK_U termed an MSK_U3, which is generated by using an MSK_D having been generated at initial device authentication for an MS, from an AAA-D server; generating a PMK by using the MSK_U3, and generating an AK by using the PMK, wherein an AAA-U server generates the MSK_U by performing user re-authentication for the MS according to an EAP-in-EAP scheme.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating an internal structure of an IEEE 802.16e communication system employing a conventional EAP-in-EAP scheme;

FIG. 2 is a flowchart illustrating a procedure of performing re-authentication in an IEEE 802.16e communication system employing a conventional EAP-in-EAP scheme; and

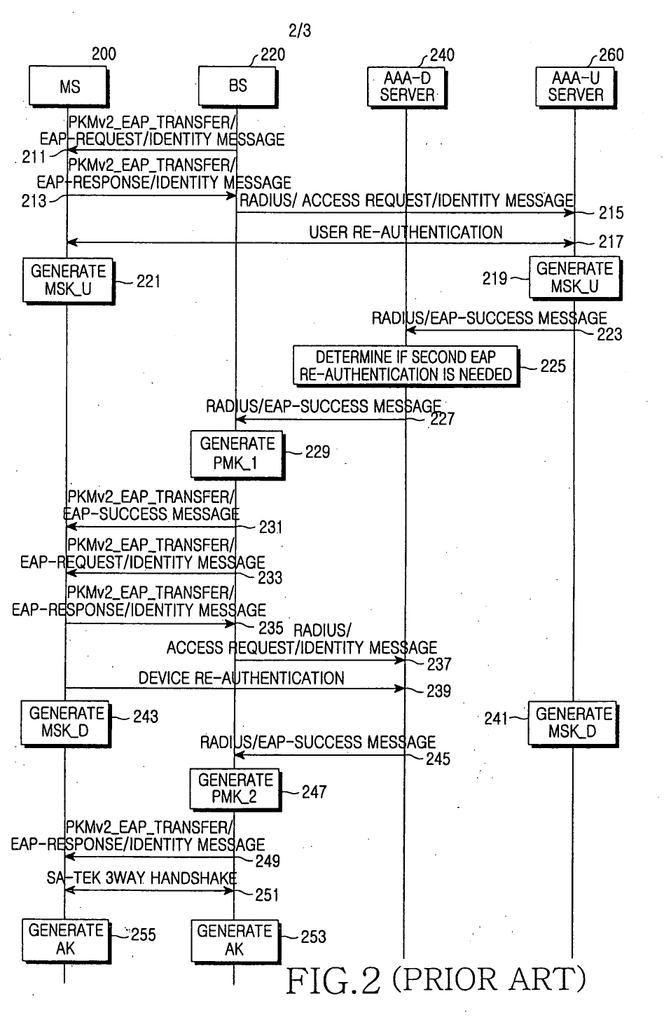

FIG. 3 is a flowchart illustrating a procedure of performing re-authentication in an IEEE 802.16e communication system employing an EAP-in-EAP scheme in accordance with the present invention.

### DETAILED DESCRIPTION OF THE PREFERRED EMBODIMENTS

Hereinafter, preferred embodiments of the present invention will be described with reference to the accompanying drawings. It should be noted that the similar components are designated by similar reference numerals although they are illustrated in different drawings. Also, in the following description, a detailed description of known functions and configurations incorporated herein will be omitted for the sake of clarity and conciseness.

The present invention discloses a system and a method for re-authenticating a user and a device together through only one EAP re-authentication in an IEEE 802.16e communication system employing a twice EAP scheme. Further, the present invention discloses a system and a method for re-authenticating a user and a device while preventing a Man-in-the-middle-Attack phenomenon even through only one EAP re-authentication in an IEEE 802.16e communication system employing a twice EAP scheme. Here, the Man-in-the-middle-Attack phenomenon refers to a phenomenon in which an abnormal user/device performs EAP-re-authentication by using a normal user/device's AK by stealth, and a detailed description thereof will be omitted because it is unrelated to the present invention.

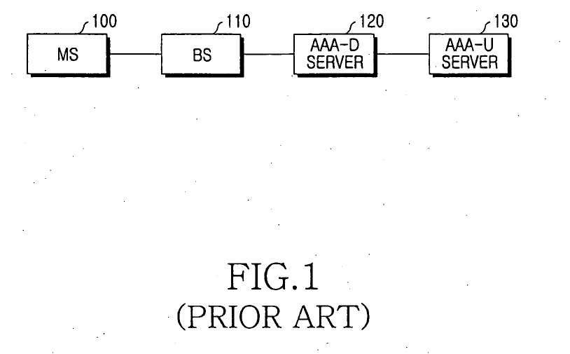

Hereinafter, since the internal structure of an IEEE 802.16e communication system employing the EAP-in-EAP scheme is the same as that described above in the Description of the Related Art with reference with FIG. 1, a detailed description thereof will be omitted. In addition, although the IEEE 802.16e communication is exemplified in the following description for the convenience of explanation, the present invention may be applied to communication systems other than the IEEE 802.16e communication system.

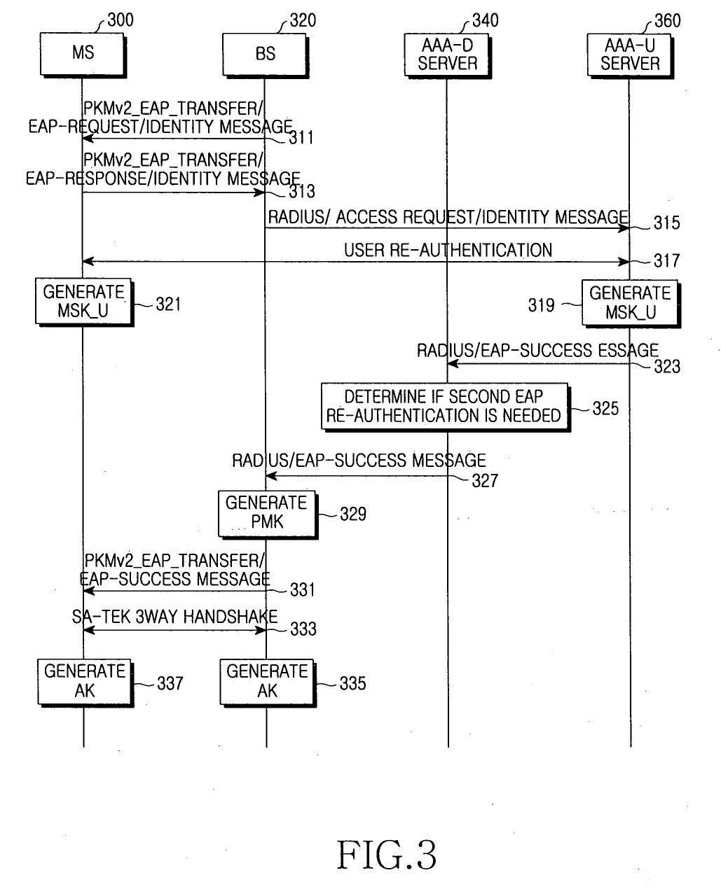

FIG. 3 is a flowchart illustrating a procedure of performing re-authentication in an IEEE 802.16e communication system employing an EAP-in-EAP scheme according to the present invention.

It is noted that re-authentication in the conventional IEEE 802.16e communication system employing a common EAP-in-EAP scheme also requires user re-authentication and device re-authentication. However, when re-authentication according to the present invention is performed, only one EAP re-authentication (hereinafter EAP re-authentication) is required for user re-authentication and device re-authentication. Referring to FIG. 3, when user re-authentication and device re-authentication are needed, a BS 320 transmits an EAP-REQUEST/IDENTITY message, which requests EAP re-authentication, to an MS 300. In the IEEE 802.16e communication system, since messages according to an EAP scheme are transmitted/received between the MS 300 and the BS 320 by using a PKMv2_EAP_TRANSFER message, the BS 320 transmits a PKMv2_EAP_TRANSFER/EAP-REQUEST/IDENTITY message to the MS 300 (step 311).

If the PKMv2_EAP_TRANSFER/EAP-REQUEST/IDENTITY message is received from the BS 320 to the MS 300, the MS 300 transmits a PKMv2_EAP_TRANSFER/EAP-RESPONSE/IDENTITY message to the BS 320 in response to the PKMv2_EAP_TRANSFER/EAP-REQUEST/IDENTITY message (step 313).

If the PKMv2_EAP_TRANSFER/EAP-RESPONSE/IDENTITY message is received from the MS 300 to the BS 320, the BS 320 forwards intact the received PKMv2_EAP_TRANSFER/EAP-RESPONSE/IDENTITY message to an AAA-U server 360. In the IEEE 802.16e communication system, messages according to the EAP scheme are transmitted/received between the BS 320 and the AAA-U server 360 by using such a message as a Remote Authentication Dial-In User Service (RADIUS) protocol message or a DIAMETER protocol message. Particularly, in FIG. 3, messages according to the EAP scheme are transmitted/received between the BS 320 and the AAA-U server 360 by using the RADIUS protocol message. Thus, the BS 320 transmits a RADIUS/ACCESS REQUEST/IDENTITY message to the AAA-U server 360 (step 315).

If the RADIUS/ACCESS REQUEST/IDENTITY message is received from the BS 320 to the AAA-U server 360, the AAA-U server 360 performs user re-authentication for the MS 300 in such a manner that it re-authenticates the PKMv2_EAP_TRANSFER messages by using a scheme such as an EAP-Message-Digest5 (EAP-MD5) scheme or an EAP-Microsoft Challenge Authentication Protocol version 2 (EAP-MSCHAPv2) scheme (step 317). If re-authentication for the MS 300 is completed in this manner, the AAA-U server 360 and the MS 300 share a user Master Session Key (MSK_U) (steps 319 and 321).

Subsequently, the AAA-U server 360 transmits a RADIUS/EAP-SUCCESS message containing the MSK_U and indicating that the EAP re-authentication was successful, to an AAA-D server 340 (step 323). The AAA-D server 340 recognizes successful user re-authentication for the MS 300 by receiving the RADIUS/EAP-SUCCESS message from the AAA-U server 360, and determines whether the second EAP re-authentication is necessary (step 325). Since device re-authentication as well as user re-authentication can be performed by only one EAP re-authentication in the present invention, the AAA-D server determines that the second EAP-re-authentication is not necessary. Thereafter, the AAA-D server 340 generates an MSK_U1 in addition to the MSK_U (step 325). The MSK_U1 is generated by using a KDF (Key Derivation Function) function as given in the following Equation (2):
MSK_{—}U1=KDF(MSK_{—}D, MSK_{—}U|‘CombinedMSK’) (2)

In Equation (2), the KDF function generates the MSD_U1 by combining an MSK_U and an MSK_D. The MSK_D has been generated at initial authentication for the MS 300.

After the MSK_U1 is generated in this manner, the AAA-D server 340 transmits a RADIUS/EAP-SUCCESS message, which contains the MSK_U1 and indicates success in user re-authentication and device re-authentication for the MS 300, to the BS 320 (step 327). The BS 320 generates a PMK by using the MSK_U1 contained in the RADIUS/EAP-SUCCESS message received from the AAA-D server 340 (step 329). The BS 320 also transmits a PKMv2_EAP_TRANSFER/EAP-SUCCESS message indicating success in user re-authentication and device-re-authentication to the MS 300 (step 331).

Through steps 311 to 331, if user re-authentication and device re-authentication for the MS 300 are completed in this manner, the MS 300 and the BS 320 perform a Security Association & Traffic Encryption Key 3way handshake (SA-TEK 3way handshake) operation (step 333). If the SA-TEK 3way handshake operation is completed, the MS 300 and the BS 320 generate an Authorization Key (AK) from the PMK (steps 335 and 337).

Reference will now be made in detail to a procedure of generating the AK by using the PMK.

First, the MS 300 and the BS 320 apply the PMK to an AK generation function such as the Dot16KDF function, thereby generating the AK. The Dot16KDF function can be expressed by the following Equation (3):
AK=Dot16KDF(PMK,MSID|BSID|‘AK’,160) (3)

In Equation (3), MSID denotes the identifier of an MS 300 for which EAP authentication is presently performed, BSID denotes the identifier of a BS 320, ‘AK’ represents that a key generated by the Dot16KDF function is an AK, and numeral 160 represents that the length of an AK generated by the Dot16KDF function is 160 bits. That is, the Dot16KDF function generates an AK having a length of 160 bits by using a parameter for PMK and a parameter for the concatenation of MSID and BSID.

As represented in Equation (3), the IEEE 802.16e communication system employing the EAP-in-EAP scheme according to this embodiment of the present invention can prevent the Man-in-the-middle-Attack phenomenon because it generates an AK by using a PMK that is generated using both an MSK_U having been generated at user re-authentication and a MSK_D having been generated at initial authentication. Since only one EAP re-authentication enables both user re-authentication and device re-authentication without causing the Man-in-the middle-Attack in the IEEE 802.16e communication system employing the EAP-in-EAP scheme according to this embodiment of the present invention, a resulting increase in the quantity of radio resources consumed and a rise in re-authentication time spent can be avoided, thereby improving the overall system performance.

As described above, the present invention enables both user re-authentication and device re-authentication to be performed through only one EAP re-authentication without causing the Man-in-the middle-Attack in the IEEE 802.16e communication system employing an EAP-in-EAP scheme. As a result, an increase in the quantity of radio resources consumed and a rise in re-authentication time spent, which result from performing EAP re-authentication twice in the conventional IEEE 802.16e communication system employing a common EAP-in-EAP scheme, can be avoided, which results in an improvement of the overall system performance.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for performing re-authentication in a communication system, the method comprising the steps of:
transmitting, from a user Authorization, Authentication and Accounting (AAA-U) server to a device Authorization, Authentication and Accounting (AAA-D) server, a user Master Session Key (MSK_U) which is generated by performing user re-authentication for a mobile station (MS) according to a twice Extensible Authentication Protocol (EAP-in-EAP) scheme;
generating a new MSK_U (MSK_U1), in the AAA-D server by using the MSK_U and a device Master Session Key (MSK_D) having been generated at initial device authentication for the MS, and then transmitting the MSK_U1 from the AAA-D server to a BS;
generating a Pairwise Master Key (PMK) in the base station (BS) by using the MSK_U1; and
generating an Authorization Key (AK) in the MS and the BS by using the PMK.

2. The method as claimed in claim 1, wherein the MSK_U1 is generated by combining the MSK_U and the MSK_D.

3. The method as claimed in claim 1, wherein the MSK_U1 is generated by a Key Derivation Function(KDF) given in the following equation as
MSK_{—}U1=KDF(MSK_{—}D, MSK_{—}U|‘CombinedMSK’)
where the KDF function generates the MSK_U1 by combining the MSK_U and the MSK_D.

4. The method as claimed in claim 1, wherein the AK is generated using the PMK and a parameter for concatenation of an identifier of the MS and an identifier of the BS.

5. The method as claimed in claim 1, wherein the AK is generated by a Dot16KDF function given in the following equation as
AK=Dot16KDF(PMK,MSID|BSID|‘AK’,160)
where MSID denotes an identifier of the MS, BSID denotes an identifier of the BS, ‘AK’ represents that a key generated by the Dot16KDF function is an AK, numeral 160 represents that an AK generated by the Dot16KDF function has a length of 160 bits, and the Dot16KDF function generates an AK having a length of 160 bits by using the PMK and a parameter for concatenation of the MSID and the BSID.

6. A system for performing re-authentication in a communication system, the system for performing re-authentication comprising:
a user Authorization, Authentication and Accounting (AAA-U) server for transmitting a user Master Session Key (MSK_U), which is generated by performing user re-authentication for a mobile station (MS) according to a twice Extensible Authentication Protocol (EAP-in-EAP) scheme, to a device Authorization, Authentication and Accounting (AAA-D) server;
the AAA-D server for generating a new MSK_U (MSK_U1) by using the MSK_U and a device Master Session Key (MSK_D) having been generated at initial device authentication for the MS, and then transmitting the MSK_U1 to a base station (BS);
the BS for generating a Pairwise Master Key (PMK) by using the MSK_U1, and generating an Authorization Key (AK) by using the PMK; and
the MS for generating the AK by using the PMK.

7. The system for performing re-authentication as claimed in claim 6, wherein the AAA-D server generates the MSK_U1 by combining the MSK_U and the MSK_D.

8. The system for performing re-authentication as claimed in claim 6, wherein the AAA-D server generates the MSK_U1 by a Key Derivation Function (KDF) given in the following equation as,
MSK _{—}U1=KDF(MSK_{—}D, MSK_{—}U|‘CombinedMSK’)
where the KDF function generates the MSK_U1 by combining the MSK_U and the MSK_D.

9. The system for performing re-authentication as claimed in claim 6, wherein the BS generates the AK by using the PMK and a parameter for concatenation of an identifier of the MS and an identifier of the BS.

10. The system for performing re-authentication as claimed in claim 6, wherein the MS generates the AK by using the PMK and a parameter for concatenation of an identifier of the MS and an identifier of the BS.

11. The system for performing re-authentication as claimed in claim 6, wherein the BS generates the AK by a Dot16KDF function given in the following equation as,
AK=Dot16KDF(PMK,MSID|BSID|‘AK’,160)
where MSID denotes an identifier of the MS, BSID denotes an identifier of the BS, ‘AK’ represents that a key generated by the Dot16KDF function is the AK, numeral 160 represents that the AK generated by the Dot16KDF function has a length of 160 bits, and the Dot16KDF function generates the AK having a length of 160 bits by using the PMK and a parameter for concatenation of the MSID and the BSID.

12. The system for performing re-authentication as claimed in claim 6, wherein the MS generates the AK by a Dot16KDF function as given in a following equation,
AK=Dot16KDF(PMK,MSID|BSID|‘AK’,160)
where MSID denotes an identifier of the MS, BSID denotes an identifier of the BS, ‘AK’ represents that a key generated by the Dot16KDF function is the AK, numeral 160 represents that the AK generated by the Dot16KDF function has a length of 160 bits, and the Dot16KDF function generates the AK having a length of 160 bits by using the PMK and a parameter for concatenation of the MSID and the BSID.

13. A method for performing re-authentication in a communication system, the method comprising the steps of:
receiving a user Master Session Key (MSK_U), which is generated by performing user re-authentication for a mobile station (MS) according to a twice Extensible Authentication Protocol (EAP-in-EAP) scheme, from a user Authorization, Authentication and Accounting (AAA-U) server; and
generating a new MSK_U (MSK_U1) by using the MSK_U and a device Master Session Key (MSK_D) having been generated at initial device authentication for the MS, transmitting the MSK_U1 to a base station (BS), and controlling the BS to generate a Pairwise Master Key (PMK) by using the MSK_U1.

14. The method as claimed in claim 13, wherein the MSK_U1 is generated by combining the MSK_U and the MSK_D.

15. The method as claimed in claim 13, wherein the MSK_U1 is generated by a Key Derivation Function (KDF) given in the following equation as,
MSK_{—}U1=KDF(MSK _{—}D, MSK_{—}U|‘CombinedMSK’)
where the KDF function generates the MSK_U1 by combining the MSK_U and the MSK_D.

16. A method for performing re-authentication in a -communication system, the method comprising the steps of:
receiving a user Master Session Key (MSK_U) and a new MSK_U (MSK_U1), which is generated by using a device Master Session Key (MSK_D) having been generated at initial device authentication for a mobile station (MS), from a device Authorization, Authentication and Accounting (AAA-D) server;
generating a Pairwise Master Key (PMK) by using the MSK_U1; and
generating an Authorization Key (AK) by using the PMK, wherein a user Authorization, Authentication and Accounting (AAA-U) server generates the MSK_U by performing user re-authentication for the MS according to a twice Extensible Authentication Protocol (EAP-in-EAP) scheme.

17. The method as claimed in claim 16, wherein the MSK_U1 is generated by combining the MSK_U and the MSK_D.

18. The method as claimed in claim 16, wherein the MSK_U1 is generated by a Key Derivation Function (KDF) given in the following equation as,
MSK_{—}U1=KDF(MSK_{—}D, MSK _{—}U|‘CombinedMSK’)
where the KDF function generates the MSK_U1 by combining the MSK_U and the MSK_D.

19. The method as claimed in claim 16, wherein the AK is generated by using the PMK and a parameter for concatenation of an identifier of the MS and an identifier of the BS.

20. The method as claimed in claim 16, wherein the AK is generated by a Dot16KDF function given in the following equation as,
AK=Dot16KDF(PMK, MSID|BSID|‘AK’,160)
where MSID denotes an identifier of the MS, BSID denotes an identifier of the BS, ‘AK’ represents that a key generated by the Dot16KDF function is the AK, numeral 160 represents that the AK generated by the Dot16KDF function has a length of 160 bits, and the Dot16KDF function generates the AK having a length of 160 bits by using the PMK and a parameter for concatenation of the MSID and the BSID.
